(19) United States
(12) Patent Application Publication
(10) Pub. No.: US 2003/0004729 A1
(43) Pub. Date: Jan. 2, 2003

(54) Handheld device with enhanced speech capability

(76) Inventors: Karl H. Allen, Portland, OR (US); Rohan Coelho, Portland, OR (US); Michael J. Payne, Beaverton, OR (US)

Correspondence Address: Edwin H. Taylor, Blakely, Sokoloff, Taylor & Zafman LLP, Seventh Floor, 12400 Wilshire Boulevard, Los Angeles, CA, 90025-1030, US

(21) Appl. No.: 09/896,350

(22) Filed: Jun. 28, 2001

(51) Int. Cl. G10L 21/00

(52) U.S. Cl. 704/275

(57) ABSTRACT

A handheld device incorporating three (3) dual ported microphones and digital-signal-processing is described. A buffer is used to capture speech that may have occurred prior to a users depressing a press-to-talk switch. Dual switches are used to more readily accommodate both right-handed and left-handed people.

### BACKGROUND

1. Field of the Invention

The invention relates to the field of speech capturing and processing particularly for a handheld computer device.

2. Prior Art

Handheld computer devices such as a palm-top computer are now commonly used for a variety of applications such as calendaring, messaging, and numerous others. These devices are often used in noisy environments such as in cars and airplanes as well as other settings with considerable background noise. It is accepted that the ease of use of these devices is enhanced if speech recognition can be effectively incorporated. The incorporation of effective speech recognition is challenging in view of the noisy environment in which the handheld devices are often used.

As will be seen, the present invention provides enhancements for enriched speech recognition in a handheld device.

### BRIEF DESCRIPTION OF THE DRAWINGS

FIG. 1 is a perspective view of a handheld device in accordance with an embodiment of the present invention.

FIG. 2 is a left side view of the device of FIG. 1.

FIG. 3 is a bottom view of the device of FIG. 3.

FIG. 4 is a block diagram showing various hardware and software components used with the present invention.

FIG. 5 is a timing diagram used to describe the presampling of the speech signal which occurs with one embodiment of the present invention.

### DETAILED DESCRIPTION

A method and apparatus is disclosed for a handheld device for enriching the device's ability for applications such as speech recognition. In the following description, in some instances, specific details are set forth in order to provide a thorough understanding of the present invention. It will be apparent to one skilled in the art that the present invention may be practiced without these specific details. In other instances well known circuits, processes and the like, have not been described in detail in order not to unnecessarily obscure the present invention.

The term handheld device refers to a handheld one-way or two-way wireless paging computer, a wireless enabled palm-top computer, a mobile telephone with data messaging capabilities or like handheld devices. In the following description, the word “application” is sometimes used to indicate a computer program operating on a processor, for instance, a microprocessor, microcontroller or the like.

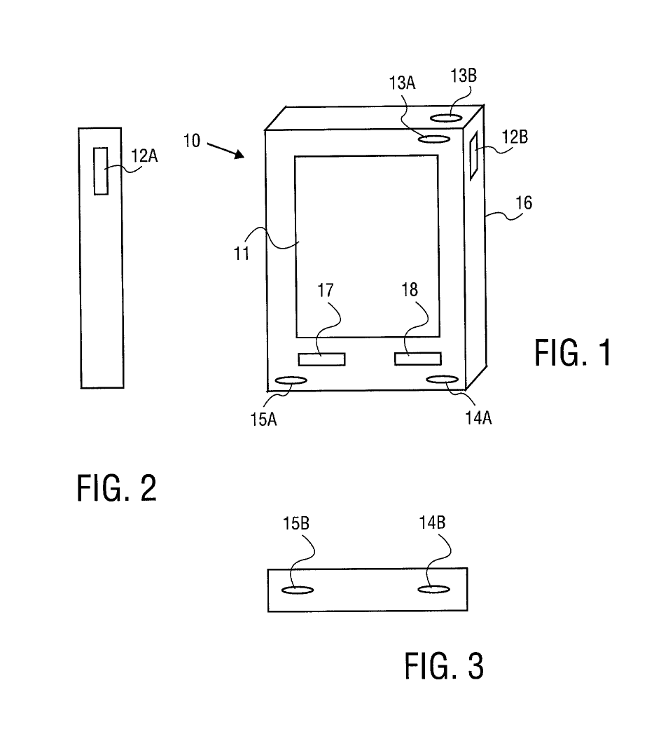

Referring now to FIG. 1, a handheld device 10 is illustrated which includes a generally rectilinear housing 16 fabricated from a material such as plastic. The interior of the housing contains a printed circuit board for the electronics needed to operate the handheld device, such as a microprocessor, memory, and other logic. The front face of the housing 16 includes a display 11 as well as buttons 17 and 18.

In one embodiment, three (3) dual port microphones are incorporated into the housing 16. A first dual ported microphone includes one port 13A incorporated into the front face of the device and a second port 13B incorporated into the upper surface of the handheld device. A second microphone includes a first port 14A incorporated into the front face of the handheld device and a second port 14B incorporated into the bottom of the device as shown in FIG. 3. A third microphone, includes a first port 15A incorporated into the front face of the device and second port 15B incorporated into the bottom of the housing 16 as shown in FIG. 3.

Also incorporated into opposite sides of the housing 16 are two manually operated switches 12A and 12B. One switch, 12B, is visible in the perspective view of FIG. 1 and the other switch, 12A, is visible in FIG. 2. These switches protrude from the surface of the housing 16 so that they may be readily activated by the fingers or palm when the device is held in the hand. The depressing of either or both of the switches is detected in software as an event, specifically, a press-to-talk event or speech event. Therefore, when the switch is pressed, it is assumed that a user is speaking into the microphones of the handheld device.

The dual port microphones are widely used in noise cancellation applications. One port of the microphone faces the expected source of the speech which is to be captured and the other port is disposed in a surface facing away from the expected source of speech. Thus, the intensity of speech is greater at one port than the other. Both ports, however, receive background noise. These microphones, in effect, subtract out the noise and provide a first level of noise cancellation. The dual ports of each microphone provide an audio analog signal representing the speech directed at the handheld device. While three dual ported microphones are shown in the drawings, more than three may be used.

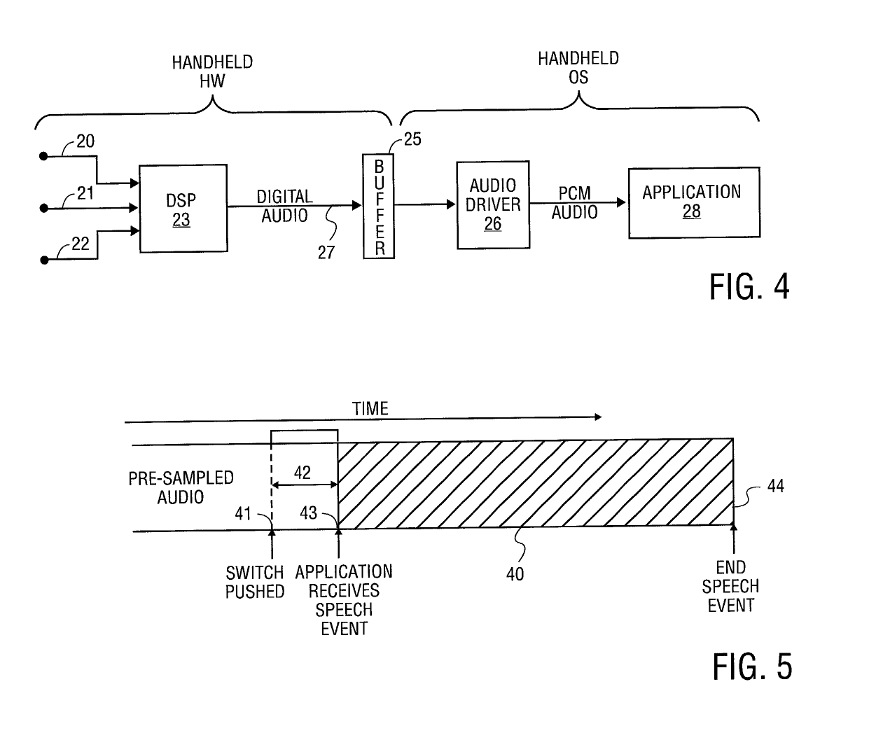

As shown is FIG. 4, the analog audio signal from each of the three dual port microphones is coupled to a digital-signal-processor (DSP) 23 on one of the lines 20, 21 and 22. In one embodiment, the DSP 23 after digitizing the analog signal from each microphone, processes the multiple audio streams by using algorithms for background noise cancellation and automatic gain control. The DSP 23, for instance, takes the digitized audio streams to triangulate which audio source (which microphone) is closest to the speaker. Once that is determined, the two other audio sources (the other microphones) that are not nearest the speaker are used for additional background noise rejection. In effect, as known in the prior art, a three-dimensional cone is created with the three audio streams. This enables the distinction between noise and speech. Moreover, the cone moves dynamically as the position of the source of the speech changes relative to the position of the handheld device. As is typically the case, as one speaks into a handheld device, there is relative motion between the speaker and the device as the head and hand move.

Additionally, the DSP 23 performs automatic gain control to compensate for how far the handheld device is held from the speaker and for changes in the speaker's volume during speech input. The speaker's volume can change during speech input through movement of the handheld device as described above in connection with the cone. The automatic gain control can compensate for these changes and provide a speech recognition engine with a constant level audio signal which improves recognition.

The output of the DSP 23 is a single stream of digitized signals representing speech which is connected on line 27 to a buffer 25. The buffer provides storage for the audio stream, for instance, in dynamic random-access memory (DRAM) or static random-access memory (SRAM). In one embodiment, the buffer 25 stores approximately one second of speech.

The DSP 23 and buffer 25 of FIG. 4 are shown under the bracket “Handheld HW.” In one embodiment, specific hardware such as the DSP 23 and a buffer 25 are used to provide a single audio stream with the nose cancellation and gain contact. The bracket to the right of the buffer 25, identified as “Handheld OS” is used to indicate that in one embodiment, the remainder of the processing occurs in software. This software may be part of the operating system (OS) of the handheld device. This includes the audio driver 26, which provides a pulse code modulated audio signal to an application 28. The output of the buffer 25 is coupled through the driver 26 into the application 28 where, for instance, voice recognition occurs. In practice, the DSP algorithms are tuned for compatibility with the speech recognition engine of the application 28.

One important aspect of providing clear speech recognition involves the ability to rapidly recognize when speech input is occurring. Providing the user the ability to easily input speech is important. Thus, one issue when capturing speech is determining how a user might begin a speech event. In may cases, a user may begin speaking at the exact moment or slightly before a press-to-talk switch is depressed. Additionally, there will always be a delay between when the switch event occurs and when the application recognizes that the event occurred. Part of the speech may be lost, not only because the user depresses the switch late, but also because of the time required for the application to recognize that the switch is depressed.

In one embodiment, presampling of the speech occurs as will be discussed. Additionally, a real-time event handler is used to reduce the delay in reporting the event to the application 28. This requires frequent monitoring of the state of the switches in order to detect a change in the state of one or both of the switches.

Audio is continuously captured by the microphones of FIG. 1 (even if it is only background noise) and processed through the DSP 23. The last, for instance, second of audio is stored within the buffer 25. The buffer thus retains a moving window in time of audio which preceeds the activation of one or both of the press-to-talk switches 12A and 12B. This is shown in FIG. 5 on the time line 40.

Assume that one or both of the switches 12A or 12B is depressed at time 41 (speech event). Prior to that time, presampled audio of, for example, one second has been stored in the buffer 25. At time 43, the application receives the indication of the speech event. Time 42 thus represents the latency period between the speech event and the actual recognition of such event by the application 28. Between time 43 and 44, any speech occurring is processed. At time 44, the speech event ends as sensed by the release of the press-to-talk switches. When the application is first notified of the event, (time 43), the audio stored within the buffer 25 is first processed by the application 28. Thus speech that may have occurred prior to time 41 and during time 42 is captured.

Acccordingly, the presampling of the audio signal allows an application interested in the speech input to listen to any speech occurring prior to the speech event. When a speech event notification does arrive, the application can include the pre-determined period of the audio stream that is buffered prior to the speech event in the overall processing. Additionally, by using real-time event notification, the application can rely on the fact that the time frame from the time of the speech event to when the application is notified is fixed, (e.g. time 42). An application that uses the presampling mechanism is more immune to speech starting before or during a speech event and is thus able to provide the user a much richer speech experience by not misrecognizing speech input in this context. It also allows for a wide variety of speech input behavior by the user rather than enforcing stricter requirements on the user.

The use of the two press-to-talk switches, one on either side of the handheld device, allows a right-handed or left-handed person to more easily use the device. It eliminates the need for users to alter their behavior on how they would naturally hold or use a handheld device. The depression of either or both of these press-to-talk switches, as mentioned, is detected by software as a speech event. Tuned switch drivers for rapid notification of a speech event are used.

Thus, an improved handheld device providing enhanced speech recognition has been disclosed.

1. A handheld device comprising:
a switch for event indicating a speech event;
a buffer for storing signals representative of audio, and
an application responsive to the speech event, for processing signals representative of audio stored in the buffer prior to the speech event.

2. The handheld device defined by claim 1 wherein the switch is a press-to-talk switch.

3. The handheld device defined by claim 2 wherein the application includes speech recognition.

4. The handheld device defined by claim 3 including a plurality of dual ported microphones for capturing the audio.

5. The handheld device defined by claim 3 including three or more microphones.

6. The handheld device defined by claim 5 wherein the microphones are coupled to a digital-signal-processor (DSP).

7. The handheld device defined by claim 6 wherein the DSP includes noise cancellation.

8. The handheld device defined by claim 7 wherein the microphones are each dual port microphones.

9. The handheld device defined by claim 8 wherein the DSP provides gain control.

10. A handheld device comprising:
a housing;
a plurality of microphones disposed on the housing;
a digital-signal-processor (DSP) disposed within the housing coupled to the microphones for providing noise cancellation for audio signals from the microphones.

11. The handheld device defined by claim 10 including:
a first switch disposed on the housing;
an application responsive to signals representing audio and a speech event; and
a buffer for storing signals representing audio, the application in response to the speech event receiving signals representing audio stored prior to the speech event.

12. The handheld device defined by claim 11 wherein there are three or more dual ported microphones.

13. The handheld device defined by claim 12 including a second switch, the first and second switches being disposed on opposite sides of the housing providing the speech event.

14. A handheld device comprising:
a housing;
an application responsive to signals representing audio and an activation signal, disposed within the housing;
a first and second press-to-talk switches disposed on opposite sides of the housing to provide the activation signal.

15. The handheld device defined by claim 13 wherein the application includes speech recognition.

16. The handheld device defined by claim 15 including a plurality of dual ported microphones.

17. The handheld device defined by claim 16 including three or more microphones.

18. The handheld device defined by claim 15 wherein the microphones are coupled to a digital-signal-processor (DSP).

19. The handheld device defined by claim 18 wherein the DSP includes noise cancellation and gain control.

20. A method for operating a voice recognition application comprising:
activating the application upon a pre-determined event;
storing audio signals;
processing audio signals by the application stored prior to the event.

21. The method defined by claim 20 wherein the storing comprises storing a pre-determined period of signals representing audio.

22. The method defined by claim 21 wherein the application provides voice recognition.

23. The method defined by claim 22 wherein the pre-determined event comprises recognizing the state of at least one switch.

24. The method defined by claim 22 wherein the pre-determined event comprises recognizing the state of either or both of two switches.

25. The method defined by claim 20 including the receiving of audio from a plurality of dual ported microphones.

26. The method defined by claim 25 wherein the receiving of audio is from three or more microphones.

27. The method defined by claim 20 including the step of providing noise cancellation prior to processing the signal representative of audio by the application.

28. The method defined by claim 27 including the step of providing gain control prior to processing the signal representative of audio by the application.
